(19) United States
(12) Patent Application Publication
(10) Pub. No.: US 2009/0207130 A1
(43) Pub. Date: Aug. 20, 2009

(54) INPUT DEVICE AND INPUT METHOD

(75) Inventors: Hsin-Chia Chen, HsinChu (TW); Cho-Yi Lin, HsinChu (TW); Tzu-Yi Chao, HsinChu (TW)

Correspondence Address: Tung & Associates, Suite 120, 838 W. Long Lake Road, Bloomfield Hills, MI, 48302, US

(73) Assignee: PixArt Imaging Incorporation

(21) Appl. No.: 12/032,646

(22) Filed: Feb. 16, 2008

(51) Int. Cl. G09G 5/00

(52) U.S. Cl. 345/156

(57) ABSTRACT

The present invention discloses an input device and an input method. The input device comprises: a device for receiving input signals; and a processor circuit for generating control information according to comparison between a first difference between two input signals in a first direction and a second difference between two input signals in a second direction.

### FIELD OF INVENTION

The present invention relates to an input device and an input method.

### DESCRIPTION OF RELATED ART

Among various types of input devices, touch-control devices have become widely used in many applications, such as touchpad in a notebook computer, touch screen in an automatic teller machine, touch panel in a PDA or an electronic dictionary, etc. Presently there are resistance-type and capacitance-type touch control devices. A resistance-type touch control device senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control device includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

Besides resistance-type and capacitance-type touch control devices, U.S. Pat. Nos. 6,057,540; 6,621,483; and 6,677,929 disclose other types of input devices.

Typically, the above mentioned input devices generate movement information (e.g., for moving a cursor) according to locus of movement, and generate control information (e.g., for opening a menu, selecting an item from the menu, etc.) by “single click” and/or “double click”. The present invention provides another way to generate control information, in which more control instructions are available; it also provides a suitable solution to product applications where “single click” and “double click” can not be conveniently achieved, e.g., because of hardware limitations.

### SUMMARY

An object of the present invention is to provide an input device and an input method, wherein control information is generated in a manner different from that in prior art.

To achieve the above and other objects, and from one aspect of the present invention, an input device comprises: a device for receiving input signals; and a processor circuit for generating control information according to comparison between a first difference between two input signals in a first direction and a second difference between two input signals in a second direction.

From another aspect of the present invention, an input method comprises: receiving input signals; comparing a first difference between two input signals in a first direction and a second difference between two input signals in a second direction; and generating control information according to the comparison result.

Preferably, a direction state is generated according to the first and second differences, and a determination is made as to whether there is any rotation and if yes, the direction of rotation, according to a change of the direction state.

More control information can be generated according to the magnitude of rotation.

### BRIEF DESCRIPTION OF THE DRAWINGS

These and other features, aspects, and advantages of the present invention will become better understood with reference to the following description, appended claims, and accompanying drawings.

FIG. 1 shows an example wherein the present invention is applied to a mobile phone.

FIG. 2 shows the internal structure of FIG. 1.

FIG. 3 explains how to determine a direction state according to an embodiment of the present invention.

FIG. 4 is a flow chart explaining the process to determine a direction state according to an embodiment of the present invention.

FIG. 5 shows clockwise and counter clockwise rotations.

FIG. 6 is a flow chart explaining the process to generate a control instruction from rotation information according to an embodiment of the present invention.

FIG. 7 is a flow chart explaining the process to generate a control instruction from rotation magnitude according to an embodiment of the present invention.

### DESCRIPTION OF THE PREFERRED EMBODIMENTS

The input device according to the present invention may be applied to touchpad, touch panel, touch screen, and other applications such as in portable electronic devices such as mobile phone, personal digital assistant (PDA), etc. As a matter of fact, for the device and method of the present invention to work, they do not require “touching”. The term “touch control” is used in the context of the specification to imply that the present invention provides an alternative for the conventional touch control device. It does not mean that the device according to the present invention detects the position of an input device by its touching.

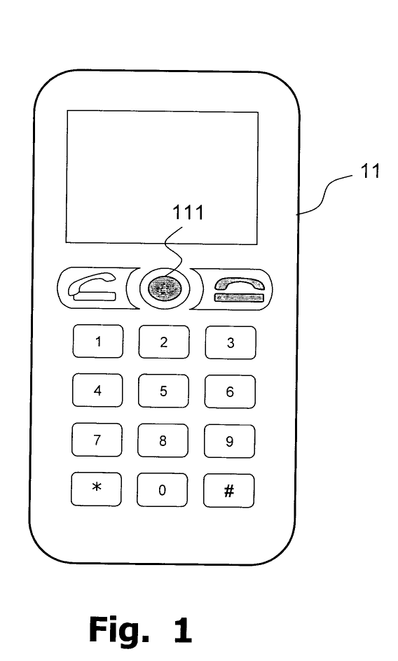

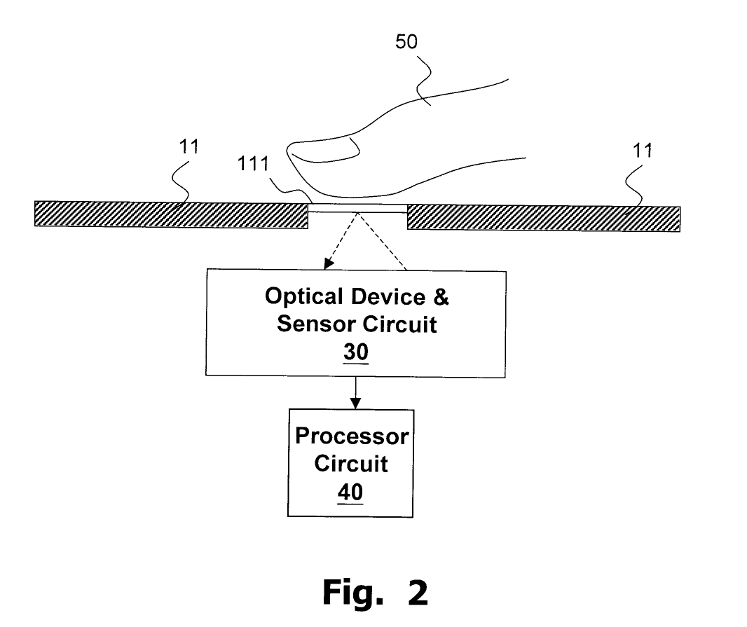

In no matter the resistance-type, capacitance-type, or optical input device, they all have to determine the locus of movement. FIG. 1 shows an example wherein the present invention is applied to a mobile phone; in this embodiment, an instruction is inputted and detected by an optical way. The mobile phone includes a housing 11 which is provided with an instruction input position 111. In a small portable electronic device, the instruction input position 111 can have a very small size; for example, most or all of its surface may be coverable by a human finger. As shown in FIG. 2, a user can move his/her finger 50 on the instruction input position 111; a optical device and sensor circuit 30 projects light and receives the fingerprint image from the instruction input position 111. The optical image is converted to electronic signals to be processed by a processor circuit 40, to generate movement information and control information. The movement information can be generated, e.g., by comparing the images at the instruction input position 111 at two time points, to determine the direction, distance and speed of the movement.

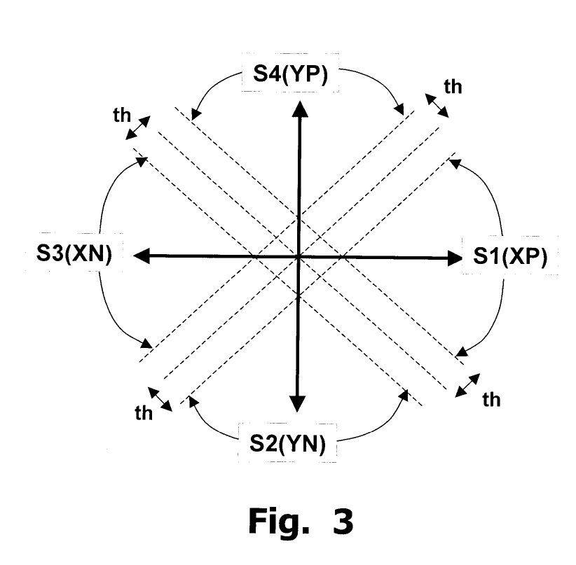

After movement information is generated, control information can be generated based on the movement information. In this embodiment:, direction information of up, down, left and right is first generated according to the direction of locus movement. Referring to FIG. 3, in one embodiment, the algorithm for determining direction is as follows:

if |ΔX| > |ΔY+th|, and ΔX > 0 ...direction state
S1(XP)
if |ΔX| > |ΔY+th|, and ΔX < 0 ...direction state
S3(XN)
if |ΔY| > |ΔX+th|, and ΔY > 0 ...direction state
S4(YP)
if |ΔY| > |ΔX+th|, and ΔY < 0 ...direction state
S2(YN)

wherein “ΔX” and “ΔY” are the differences in X and Y coordinates between two time points, respectively; “th” is a threshold to ensure a valid determined state if the difference between the absolute values of ΔX and ΔY is larger than this predetermined threshold; XP, XN, YP, and YN represent positive X coordinate direction, negative X coordinate direction, positive Y coordinate direction, and negative Y coordinate direction, respectively.

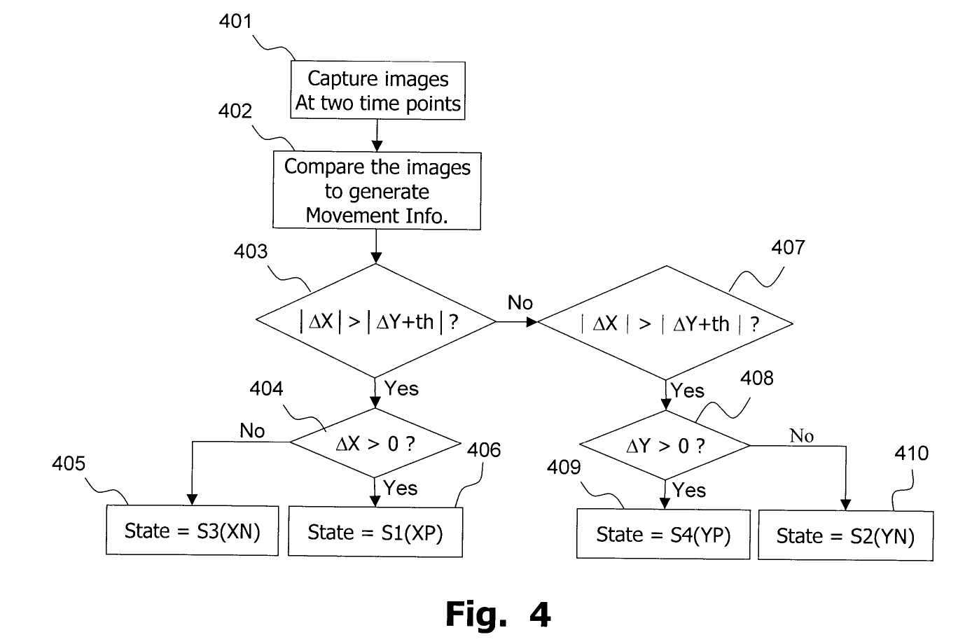

FIG. 4 shows, by way of example, a process flow to carry out the above algorithm. First at the step 401, two images at two time points are captured. Next at the step 402, the two images are compared with each other to determine the differences in X and Y coordinates. Thereafter, the steps 403-410 are taken to determine the direction state. Obviously, some of the steps in this process flow can be interchanged; this process flow is not the only way to carry out the above algorithm.

The determined direction state can be used, for example, to switch between menus. According to the present invention, a change in the direction state is further used to generate other control information, such as to replace for the “single click” and “double click”, to select an item in a menu, or for other control functions.

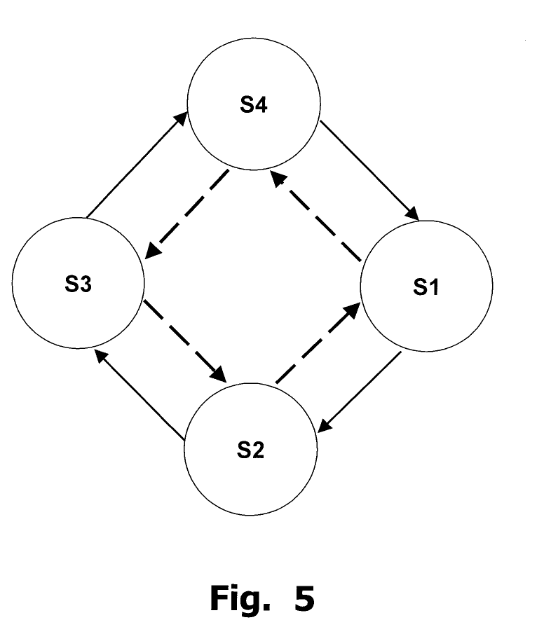

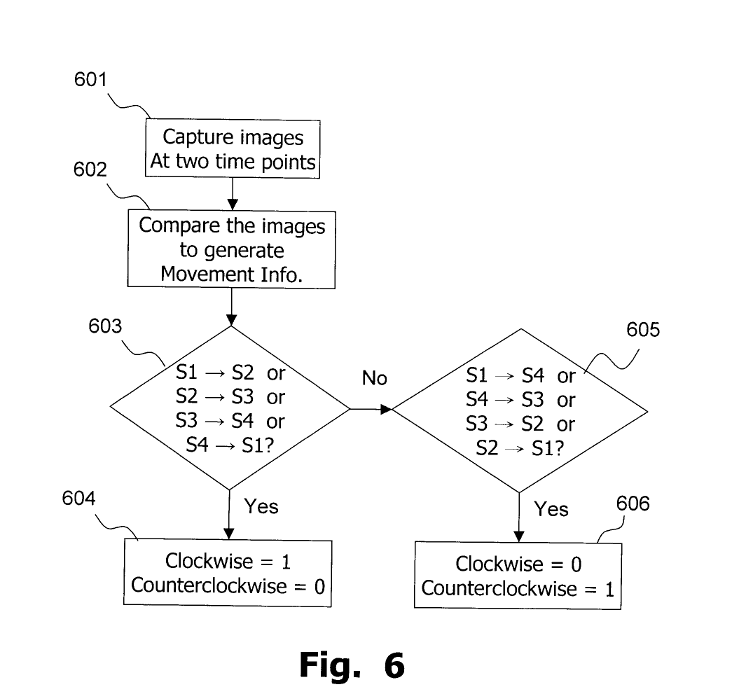

More specifically, referring to FIG. 5 and the steps 601-606 in FIG. 6, in one embodiment of the present invention, a change in the direction state is used to determine whether there is a rotation and the direction of rotation, to generate more control information. The algorithm for determination for example can be as follows:

```
when the direction state changes from S1 to S2, or
from S2 to S3, or from S3 to S4, or from S4 to S1:
                    .....clockwise rotation,
                set the clockwise flag to 1, and
                  counterclockwise flag to 0
when the direction state changes from S1 to S4, or
from S4 to S3, or from S3 to S2, or from S2 to S1:
                ..... counterclockwise rotation,
            set the counterclockwise flag to 1, and
                        clockwise flag to 0
```

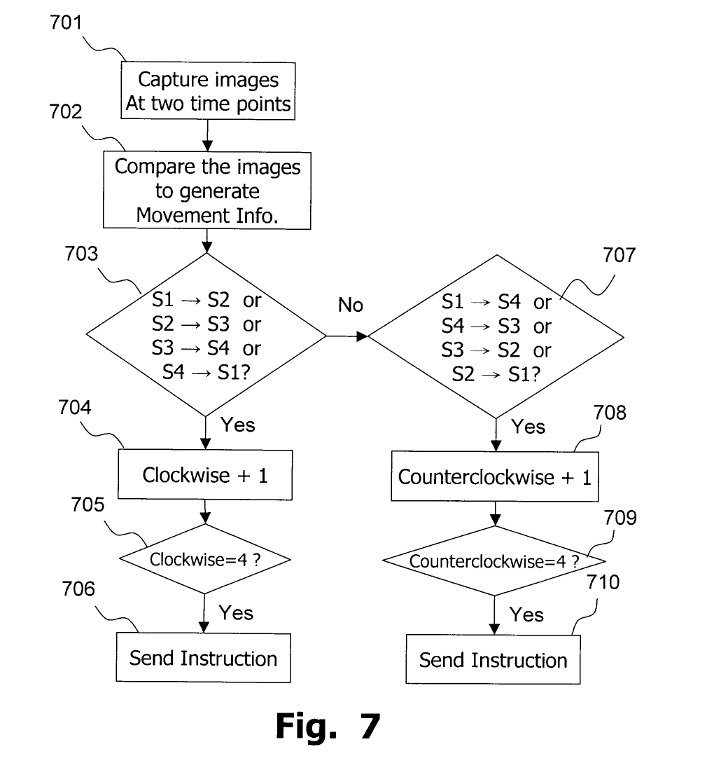

“The existence of rotation” and “the direction of rotation” can each be defined as an individual control instruction. Moreover, referring to FIG. 5 and the steps 701-710 in FIG. 7, in another embodiment of the present invention, the magnitude of rotation can be used to define more instructions, for example as follows:

```
when the direction state changes from S1 to S2, or
from S2 to S3, or from S3 to S4, or from S4 to S1:
                        .....clockwise rotation,
                add 1 to the clockwise count, and
              reset the counterclockwise count to 0
when the direction state changes from S1 to S4, or
from S4 to S3, or from S3 to S2, or from S2 to S1:
                  ..... counterclockwise rotation,
            add 1 to the counterclockwise count, and
                  reset the clockwise count to 0
when the clockwise count or the counterclockwise count
reaches a predetermined number (for example, 4)
              .....send a corresponding instruction
```

Thus, more number of control instructions can be provided, as compared with the conventional “single click” and “double click”. And, because it is not required to press the instruction input position 111, on the one hand there will be no misclick error, and on the other hand it is not required to install any mechanical press-control components inside the housing 11. Such advantages are even more significant in a small size portable electronic device.

The spirit of the present invention has been explained in the foregoing with reference to its preferred embodiments, but it should be noted that the above is only for illustrative purpose, to help those skilled in this art to understand the present invention, not for limiting the scope of the present invention. Within the same spirit, various modifications and variations can be made by those skilled in this art. For example, the present invention can be applied to any small size or large size, portable electronic device or non-portable apparatuses, other than the mobile phone shown in FIG. 1. The method to generate instructions by the clockwise and counterclockwise rotation and count, can be used in any input device other than an optical input device. The optical device and sensor 30, and the processor circuit 40, are shown to be two separate devices, but they can be integrated into one device, or separated into more number of devices. Instead of the horizontal and vertical coordinates (X and Y coordinates), any two axes intersected orthogonally or non-orthogonally with each other can be used as the reference coordinates. In view of the foregoing, it is intended that the present invention cover all such modifications and variations, which should be interpreted to fall within the scope of the following claims and their equivalents.

What is claimed is:

1. An input device, comprising:
a device for receiving input signals; and
a processor circuit for generating control information according to comparison between a first difference between two input signals in a first direction and a second difference between two input signals in a second direction.

2. The input device as claimed in claim 1, wherein the control information includes one of the followings: opening a menu, and selecting an item from a menu.

3. The input device as claimed in claim 1, wherein the input signals are optical images.

4. The input device as claimed in claim 1, wherein the input signals are fingerprint images.

5. The input device as claimed in claim 1, wherein the processor circuit generates a direction state according to the first and second differences, and generates the control information according to a change of the direction state.

6. The input device as claimed in claim 5, wherein the processor circuit compares a first absolute value of the first difference with a second absolute value of the second difference, and generates the direction state only when the difference between the first and second absolute values is larger than a predetermined threshold.

7. The input device as claimed in claim 5, wherein the processor circuit generates the control information by determining whether there is any rotation according to a change of the direction state.

8. The input device as claimed in claim 7, wherein the processor circuit further determines a direction of rotation.

9. The input device as claimed in claim 7, wherein the processor circuit further determines a magnitude of rotation.

10. The input device as claimed in claim 1, wherein the device for receiving input signals includes an optical device and sensor, which receives and converts optical signals to electronic signals, and sends the electronic signals to the processor circuit.

11. The input device as claimed in claim 1, wherein the input device is used in a portable electronic device.

12. An input method, comprising:
receiving input signals;
comparing a first difference between two input signals in a first direction and a second difference between two input signals in a second direction; and
generating control information according to the comparison result.

13. The input method as claimed in claim 12, wherein the control information includes one of the followings: opening a menu, and selecting an item from a menu.

14. The input method as claimed in claim 12, wherein the input signals are optical images.

15. The input method as claimed in claim 12, wherein the input signals are fingerprint images.

16. The input method as claimed in claim 12, further comprising: generates a direction state according to the first and second differences, and generates the control information according to a change of the direction state.

17. The input method as claimed in claim 16, wherein the step generating a direction state includes: comparing a first absolute value of the first difference with a second absolute value of the second difference, and generating the direction state only when the difference between the first and second absolute values is larger than a predetermined threshold.

18. The input method as claimed in claim 16, wherein the step generating the control information includes: determining whether there is any rotation according to a change of the direction state.

19. The input method as claimed in claim 16, wherein the step generating the control information includes: determining a direction of rotation.

20. The input method as claimed in claim 16, wherein the step generating the control information further includes: determining a magnitude of rotation.

21. The input method as claimed in claim 12, wherein the step receiving input signals includes: receiving optical signals from an instruction input position of a portable electronic device, and converting the optical signals into electronic signals.
